(19) United States
(12) Patent Application Publication
(10) Pub. No.: US 2014/0259918 A1
(43) Pub. Date: Sep. 18, 2014

(54) EXPANDABLE HANGING GARDEN WITH AUTOMATIC WATERING AND FERTILIZING DEVICE

(71) Applicant: Nathan A. Scolari, Greenville, SC (US)

(72) Inventor: Nathan A. Scolari, Greenville, SC (US)

(21) Appl. No.: 14/206,117

(22) Filed: Mar. 12, 2014

Related U.S. Application Data
(60) Provisional application No. 61/790,919, filed on Mar. 15, 2013.

(51) Int. Cl. A01G 27/00

(52) U.S. Cl. CPC A01G 27/00
USPC 47/67

(57) ABSTRACT

The invention relates generally to a hanging gardening and watering apparatus comprising: a set of trellises pivotally connected to each other and to opposing sides in a vertical scissor arrangement allowing for the frame to expand and contract varying the volume occupied by the frame; a fertilizing system carried by the frame and disposed at the top of the frame; a set of compartments included in the fertilizing system for holding additives taken from the group consisting of: fertilizer, weed killer, pre-emergent, fragrance and any combination thereof; and, a tube for directing water from a water supply to siphon additives from selected compartments so that the water and additive are mixed in the water stream and directed to a delivery system so that the mixture is delivered to plants disposed in the frame.

### BACKGROUND OF THE INVENTION

1) Field of the Invention

This invention is directed to an expandable hanging garden having a automatic device that waters and fertilizes the plants.

2) Description of Related Art

Hanging garden units are generally known in the art. However, the two primary disadvantages of the current design is lack of space for additional plants and the need for the user to remember to water and fertilize the plants in the garden unit.

Accordingly, it is an object of this invention to provide a hanging garden unit that can be placed in a compact position when not in use and that can expand to provide ample room for plants.

It is a further object of this invention to provide the unit with a device that automatically waters and fertilizes the plants in the garden unit.

It is a further object of the invention to provide a mechanism for ensuring that each of the plants in the unit receive sufficient sunlight.

### SUMMARY OF THE INVENTION

The invention relates generally to a hanging, gardening and watering apparatus comprising: a frame having rigid opposing sides providing vertical support; a set of trellises pivotally connected to each other and the opposing sides in a vertical scissor arrangement allowing for the frame to expand and contract varying the volume occupied by the frame; a plurality of support bars rotatably attached to the set of trellises at varying heights for supporting plants within the frame; a fertilizing system carried by the frame and disposed at the top of the frame; a set of compartments included in the fertilizing system for holding additives taken from the group consisting of: fertilizer, weed killer, pre-emergent, fragrance and any combination thereof; and, a tube for directing water from a water supply to siphon additives from selected compartments so that the water and additive are mixed in the water stream and directed to a delivery system so that the mixture is delivered to plants disposed in the frame.

The invention can include a ball valve attached to each compartment so that when the ball valve is opened, the additive from the compartment will be added to the water stream. There can also be a sliding valve attached to each compartment so that when the sliding valve is opened, the additive from the compartment will be added to the water stream. A water timer for selecting the time and duration of water being delivered from the water supply to the delivery system can be included. An additive timer for selecting the time, quantity and duration of each of the additives added to the water stream, by opening or closing a valve carried by each compartment according to the setting of the additive timer can be included.

The delivery system can be a perforated tube. A reflective mat disposed under the frame for reflecting light up into the frame. The delivery system can include a drip hose, a sprinkler and a delivery system valve for selecting between the drip hose, the sprinkler or both.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 shows perspective view of the invention in accordance with an embodiment of the invention;

FIGS. 2A and 2B show perspective views of aspects of the invention; and,

FIGS. 3A through 3C show top views of aspects of the invention;

FIG. 4A shows a top down view of aspects of the invention;

FIGS. 4B and 4C are side views of aspects of the invention; and,

FIG. 5 is a schematic of aspects of the invention.

It will be understood by those skilled in the art that one or more aspects of this invention can meet certain objectives, while one or more other aspects can meet certain other objectives. Each objective may not apply equally, in all its respects, to every aspect of this invention. As such, the preceding objects can be viewed in the alternative with respect to any one aspect of this invention. These and other objects and features of the invention will become more fully apparent when the following detailed description is read in conjunction with the accompanying figures and examples. However, it is to be understood that both the foregoing summary of the invention and the following detailed description are of a preferred embodiment and not restrictive of the invention or other alternate embodiments of the invention. In particular, while the invention is described herein with reference to a number of specific embodiments, it will be appreciated that the description is illustrative of the invention and is not constructed as limiting of the invention. Various modifications and applications may occur to those who are skilled in the art, without departing from the spirit and the scope of the invention, as described by the appended claims. Likewise, other objects, features, benefits and advantages of the present invention will be apparent from this summary and certain embodiments described below, and will be readily apparent to those skilled in the art. Such objects, features, benefits and advantages will be apparent from the above in conjunction with the accompanying examples, data, figures and all reasonable inferences to be drawn therefrom, alone or with consideration of the references incorporated herein.

### DETAILED DESCRIPTION OF A PREFERRED EMBODIMENT

With reference to the drawings, the invention will now be described in more detail. FIG. 1 shows a perspective view of the hanging garden unit 10 having a frame shown generally at 11. The unit has five sides and an open top where soil can be placed. In one embodiment, sides 12 and 14 are rigid while the front side, back side and bottom are all made of a flexible material so that the unit can expand and contract along direction A. The rigid sides can be opposing and provide vertical support for the frame. The flexible sides can be opposing. In one embodiment, the flexible material can be made of cloth or fabric, including but not limited to burlap, canvas or the like. In alternate embodiments, however, the material could be a semi rigid material such as plastic. Any material generally known in the art that has the capability of expanding and contracting along axis A can be used.

In the shown embodiment, the front side 15 and the back side (not shown) are provided with a plurality of trellis members 16. The trellises can be pivotally attached to each other and the rigid sides in a vertical scissor arrangement so that the frame can expand and contract. This trellis system supports the front and back side so that the soil is properly contained within the unit. The trellis members are pivotally connected to one another at point 18 so that when the unit is collapsed the trellis members will be generally parallel and adjacent to one another. Trellis members 16 also provide support for plants that are growing in the garden unit. In one embodiment, openings are provided in one or more of the unit's sides so that plants may be planted in the top of the unit as well as at various points on the side of the unit. Vine like plants may wrap around trellis members.

In one embodiment, trellis members are provided with support bars 20 so that fruit and/or vegetable bearing plants may be supported. In one embodiment, these support bars 20 are rotatably connected to the trellis members 16 to allow the unit to be compactly collapsed. In the collapsed position, the support bars can be rotated so that they are parallel to the trellis members. In alternate embodiments, however, the support bars are removable so that they may be removed when not needed or when the unit is in a collapsed position.

Garden unit 10 may be placed on the ground or it may be provided with hooks so that the unit may be suspended in the air. In one embodiment, the unit is provided with a reflective mat 22 that can be placed underneath the unit. As can be seen by FIG. 2, the mat 22 may be folded in a variety of manners including a V shape and/or a U shape to reflect light, including sunlight, on to plants that may not be getting enough sunlight due to the positioning of the unit. This mat also serves as a water catching device to ensure that any water that drips from the garden unit falls on the mat rather than staining the surface underneath the garden unit.

Referring now to FIGS. 1 and 3A through 3C, the garden unit can be provided with an automatic watering system and fertilizing system carried by the frame. As is generally known in the art, a hose 26 can be connected to one end and a ball joint can be placed on a water timer to allow water to flow out of a water outlet 28 at a predetermined time period and for a predetermined period of time. In alternate embodiments, the watering system 24 can be controlled by one or more sensors such as a soil moister sensor that is placed in the unit, a rain gauge and/or a humidity sensor. In this embodiment, the flow of water is controlled in response to the sensors detecting predetermined criteria or a lack thereof. These sensors could be mounted on the garden unit 10, placed in the soil and/or mounted on the watering system 24. Once the water is allowed to flow, it may be directed to a perforated pipe or tube 30 that can be suspended over the soil or laid on top of the soil as shown in FIG. 3. In one embodiment, the tube is a drip hose. In one embodiment, sprinklers 32 can be included in the watering system as shown in FIG. 1. In one embodiment, however, the water is directed to a water diffuser which comprises a water container having a bottom that has a number of holes so that the water is caused to drip along the entire surface of the soil below the water diffuser. Each of these components, drip hose, perforated hose, sprinklers and diffuser can be included in a water delivery system carried by the frame. A delivery system valve can be included to select between these various components or provide water delivery through a combination of these components.

As shown in FIG. 4A, the watering system can include several compartments 34, each of which may contain different fertilizers, weed killers, pre-emergent, fragrances and other additives. The compartments are fluidly connected to the main water conduit 36 by a ball valve 38, sliding valve 39 or other valve. A additive timer can be included to control the time, quantity, and duration of additive that is placed in the water stream. Once the ball valve is opened, the fertilizer is allowed to enter in the main water conduit into the water stream and mixes with the water. In one embodiment, the flow of water through the main water conduit creates a siphoning force that draws the additive into the water stream where the water and additive mix and are delivered to the plants. Depending on the amount the valve is opened and the time during which the valve stays open, the watering system is able to control the amount of fertilizer or other additive in the water stream. The type of fertilizer is determined by which ball valve is opened thus allowing the desired compartment to be in fluid communication with the main water conduit. The watering system could further include a programmable processor which controls the amount and duration that the valve is opened. This allows the user to initially program the unit so that the hanging garden unit is self sustaining with little effort required of the user.

In an alternate embodiment, the main water conduit 36 could have a section 39 that is rotatable as shown in FIG. 4B or slideable as shown in FIG. 4C. Thus, when section 31a rotates or section 31b slides it allows the compartment to be in fluid communication with the main water conduit, thus allowing the fertilizer or the like to enter the water flow.

The watering system 24 can further include a decorative fountain 37 as shown in FIG. 1. This fountain allows the user to add fragrances to the fountain to enhance the ambiance where the garden is located.

As can be seen in FIG. 5, the watering system can also be modified to maintain the user's yards and foliage. The system may be set up by a home owner and may be used with any type of hose, pvc or other generally available irrigation materials. In at least one embodiment, the watering system can serve as the control for an existing irrigation system.

In order to maintain an entire yard, the system would need to be provided with additional compartments 34 that are larger than those in the hanging garden arrangement so that more fertilizer can be stored. Also, the yard maintenance system would likely need more water outputs so that different sections of the yard can be maintained. The yard maintenance watering system could also be controlled by one or more sensors such as ground moisture, humidity and rain gauge that can be placed at various points throughout the yard. As shown in FIG. 5, the watering system could be hooked up to a water source such as a spicket 50 and then could have several water outputs 52 so that a variety of watering means could be used such as sprinklers 54, drip lines 56 and soaker hoses 58.

The watering system could be provided with a programmable processor so that the user may use interface 60 to set a schedule for water and fertilization. The system could also be provided with a manual interface 62 that would allow the user to control the flow of water and/or fertilizer manually.

While a preferred embodiment of the invention has been described using specific terms, such description is for illustrative purposes only, and it is to be understood that changes and variations may be made without departing from the spirit or scope of the following claims.

What is claimed is:

1. A hanging gardening and watering apparatus comprising:
a frame having rigid opposing sides providing vertical support;
a set of trellises pivotally connected to each other and the opposing sides in a vertical scissor arrangement allowing for the frame to expand and contract varying the volume occupied by the frame;
a plurality of support bars rotatably attached to the set of trellises at varying heights for supporting plants within the frame;
a fertilizing system carried by the frame and disposed at the top of the frame;
a set of compartments included in the fertilizing system for holding additives taken from the group consisting of: fertilizer, weed killer, pre-emergent, fragrance and any combination thereof; and,
a tube for directing water from a water supply to siphon additives from selected compartments so that the water and additive are mixed in the water stream and directed to a delivery system so that the mixture is delivered to plants disposed in the frame.

2. The apparatus of claim 1 including a ball valve attached to each compartment so that when the ball valve is opened, the additive from the compartment will be added to the water stream.

3. The apparatus of claim 1 including a sliding valve attached to each compartment so that when the sliding valve is opened, the additive from the compartment will be added to the water stream.

4. The apparatus of claim 1 including a water timer for selecting the time and duration of water being delivered from the water supply to the delivery system.

5. The apparatus of claim 1 including an additive timer for selecting the time, quantity and duration of each of the additives added to the water stream by opening or closing a valve carried by each compartment according to the setting of the additive timer.

6. The apparatus of claim 1 wherein the delivery system is a perforated tube.

7. The apparatus of claim 1 including a reflective mat disposed under the frame for reflecting light up into the frame.

8. The apparatus of claim 1 including:
a drip hose for delivering water and an additive to the plants;
a sprinkler for delivering water and an additive to the plants; and,
a delivery system valve for selecting between the drip hose, the sprinkler or both.

9. A hanging gardening and watering apparatus comprising:
an expandable frame having rigid opposing sides connected to a set of trellises in a vertical scissor arrangement for supporting plants within the frame;
a fertilizing system carried by the frame having a set of compartments included in the fertilizing system for holding additives taken from the group consisting of: fertilizer, weed killer, pre-emergent, fragrance and any combination thereof; and,
a water delivery system for selective directing water from a water supply to the compartments so that additives are siphoned from the compartments and added to the water stream and delivered to the plants.

10. The apparatus of claim 9 indulging a valve included with each compartment having an open position for allowing the additive in the compartment to enter the water stream and a closed position preventing the additive from entering the water stream.

11. The apparatus of claim 9 including a water timer for selecting the time and duration of water being delivered from a water supply.

12. The apparatus of claim 9 including an additive timer for selecting the time, quantity and duration of each of the additives added to the water stream by opening or closing a valve carried by each compartment according to the setting of the additive timer.

13. The apparatus of claim 9 including:
a drip hose for delivering water and an additive to plants contained with the frame;
a sprinkler for delivering water and an additive to the plants; and,
a delivery system valve for selecting between the drip hose, the sprinkler or both.

14. The apparatus of claim 9 including a reflective mat disposed under the frame for reflecting light up into the frame.

15. A hanging gardening and watering apparatus comprising:
an expandable frame having opposing rigid sides, opposing flexible sides, a flexible top and a set of trellises in an expandable scissor arrangement wherein the trellises support plants within the frame;
a series of compartments carried by the frame and disposed at the top of the frame for holding additives;
a water conduit attached to a water source and including openings associated with each container and in fluid communication with the container so that when water flows through the water conduit, additives are siphoned from the container and added to a water stream that is delivered to the plants; and,
a delivery system for delivering the water stream having additives to the plants.

16. The apparatus of claim 15 wherein the delivery system includes a sprinkler, a drop hose and a delivery system valve for selecting between the drip hose, the sprinkler or both.

17. The apparatus of claim 15 including an additive timer for selecting the time, quantity and duration of each of the additives added to the water stream by opening or closing a valve carried by each compartment according to the setting of the additive timer.

18. The apparatus of claim 17 wherein the operational cycle of the additive timer is greater than 12 months.

19. The apparatus of claim 15 including a reflective mat disposed under the frame for reflecting light up into the frame.

20. The apparatus of claim 15 where the additives are selected from the group consisting of weed killer, fertilizer, pre-emergent, fragrance and any combination thereof.
